(19) United States
(12) Patent Application Publication
(10) Pub. No.: US 2018/0174227 A1
(43) Pub. Date: Jun. 21, 2018

(54) System and method for placing a purchase order via sign to buy

(71) Applicants: Synergex Group, Greenwich, CT (US); Wayne Taylor, Chandler, AZ (US); Pham Holdings Inc., Lacey, WA (US)

(72) Inventor: Thien Pham, Lacey, WA (US)

(73) Assignees: Synergex Group, Greenwhich, CT (US); Wayne Taylor, Chandler, AZ (US); Pham Holdings, Lacey, WA (US)

(21) Appl. No.: 15/382,710

(22) Filed: Dec. 18, 2016

(51) Int. Cl. G06Q 30/06; G06Q 20/24; G06Q 20/40

(52) U.S. Cl. CPC G06Q 30/0635; G06Q 30/0641; G06Q 20/40145; G06Q 20/24

(57) ABSTRACT

System and method for placing a purchase order via sign to buy.

### CROSS-REFERENCE TO RELATED APPLICATIONS

Not Applicable.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates generally to a computer method and system for placing an order by clicking on a sign to buy button or other similar button with the same intent.

### BACKGROUND OF THE INVENTION

Internet purchases from online stores are becoming the way of life as more and more people are buying all their household items, electronics, services, and more. Internet purchases offer the convenience of just browsing a website, placing the order, and paying with a credit card. The information entered into the online store hosting the payment page is prone to various cyberattacks and personal information can be stolen. There needs to be a quick and secure method for making online purchases to prevent fraudulent purchases made from stolen credit cards. What is needed is a system and method for placing a purchase order via sign to buy whereby clicking on a sign to buy button or similar button activates a biometric signature verification program that verifies the identity of the person making the purchase. Once verified and payment has been authorized, the purchase is then processed for shipping.

### BRIEF SUMMARY OF THE INVENTION

In a typical application, a user has signed into his/her account and is at the last step of the checkout process on a website or in an application. A button “Sign to Buy” or similar button with the same intent is displayed as a method to quickly pay for the purchase by just signing with a signature on the screen or using a digitizer to generate a signature. The user clicks on the button and it activates a biometric signature verification program. The biometric signature verification program requests the user to sign his/her signature on the screen using his/her finger, stylus, or any pointer device capable of generating a signature on the screen for the biometric signature verification server. Once the biometric signature sample is successfully validated by the biometric signature server, the program connects to the user database server where the user's default credit card is stored to retrieve the credit card information. Once the credit card information has been retrieved, the program then passes the credit card information to a payment gateway for processing. If the payment gateway comes back with a successful processing, the program returns a transaction ID and the biometric signature sample is then stored to the order history database server along with the order information and transaction id for future reference.

### BRIEF DESCRIPTION OF THE SEVERAL VIEWS OF THE DRAWING

FIG. 1 illustrates an exemplary environment where a “Sign to Buy” button is displayed for the user to click on.

FIG. 2 illustrates an exemplary environment for completing a purchase order via sign to buy in a network environment.

FIG. 3 illustrates the method for placing a purchase order via sign to buy.

### DETAILED DESCRIPTIONS OF THE INVENTION

The invention is now described in detail with reference to an embodiment thereof as illustrated in the accompanying drawing. In the following description, numerous specific details are set forth in order to provide thorough understanding of the present disclosure. It is apparent, however, to one skilled in the art, that the present discloser may be practiced without some or all of these specific details. In other instances, well known process steps and/or structures have not been described in detail in order not to unnecessarily obscure the present disclosure. In addition, while the disclosure is described in conjunction with the particular embodiment, it should be understood that this description is not intended to limit the disclosure to the described embodiment. To the contrary, the description is intended to cover alternatives, modifications, and equivalents as may be included within the spirit and scope of the disclosure as defined by the appended claims.

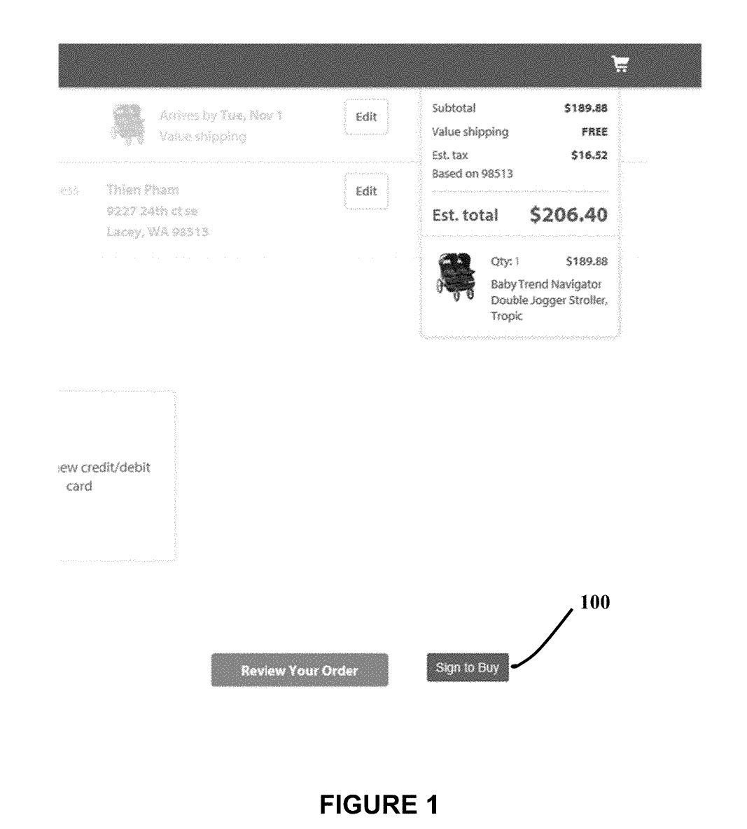

FIG. 1 illustrates an exemplary environment in which an online store or an application running on Device 260 displays a “Sign to Buy” button 100. The “Sign to Buy” button can be an image or any other text that has the same intent. Once the user clicks on the “Sign to Buy” button 100, the program begins to request the user to provide his/her signature, connects to the Biometric Signature Server 220 to verify the collected signature, gets the default credit card on file for the user by connecting to the User Database Server 200, processes the payment using the default credit card on file by connecting to the Payment Gateway 230, returns a payment gateway transaction id, and stores the collected signature and transaction id to the Order History Database Server 210.

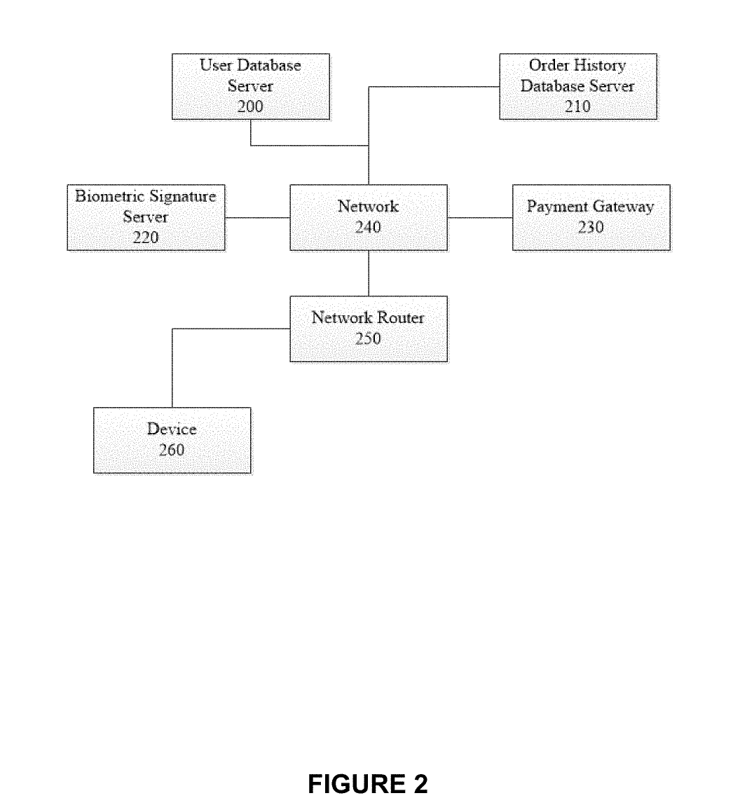

FIG. 2 illustrates an exemplary environment for completing a purchase order via sign to buy in a network environment. The sign to buy method runs in an application that is hosted on Device 260. Device 260 is coupled to the User Database Server 200 via the Network Router 250 and the Network 240. Device 260 is coupled to the Biometric Signature Server 220 via the Network Router 250 and the Network 240. Device 260 is coupled to the Order History Database Server 210 via the Network Router 250 and the Network 240. Device 260 is coupled to the Payment Gateway 230 via the Network Router 250 and the Network 240.

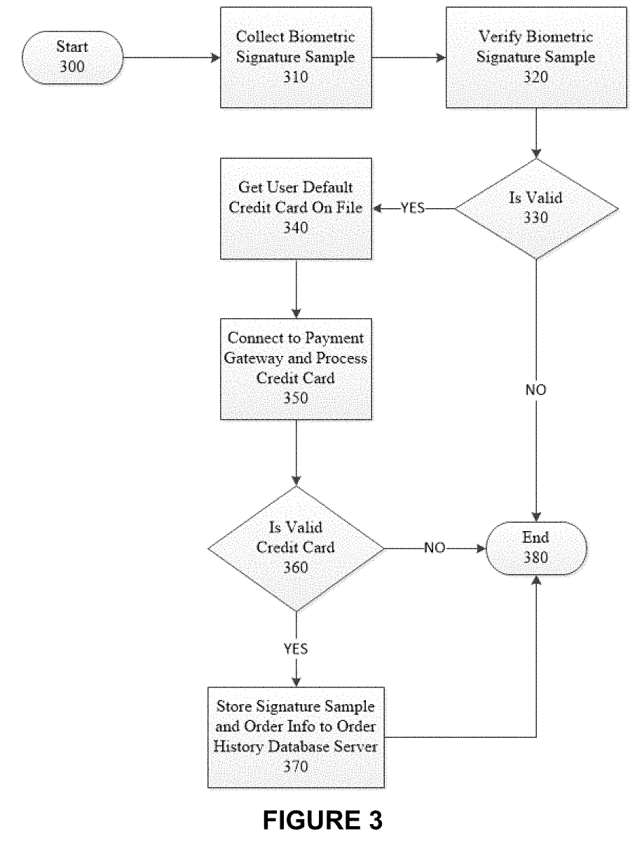

FIG. 3 illustrates the method for sign to buy. The method for sign to buy is represented as a computer function that takes in two parameters, the amount of the purchase order and the user unique identifier. In the most general form, this function can be expressed using pseudo code:

function SignToBuy(userID, orderID, amount)

where userID is the user unique identifier,

orderID is the unique order identifier, and

amount is the purchase order amount as a number greater than zero.

The program starts at step 300 and continues to step 310. At step 310, the program requests the user to sign his/her signature using the movement of the user's finger, stylus, or computer mouse. Once the signature sample is collected, the program continues to step 320. At step 320, the program connects to the Biometric Signature Server 220 via the Network Router 250 and the Network 240 and submits the signature sample collected at step 310 for verification and continues to step 330. If the biometric signature sample collected at step 310 is valid at step 330, the program continues to step 340. If at step 330, the signature sample collected at step 310 is invalid, the program continues to step 380 where it ends. At step 340, the program connects to the User Database Server 200 via the Network Router 250 and the Network 240 and retrieves the default credit card information on file and continues to step 350. At step 350, the program connects to the Payment Gateway 230 via the Network Router 250 and the Network 240 to process the payment using the credit card information retrieved at step 340 and the amount submitted to the program. The program then continues to step 360. If at step 360, the payment is processed successfully by the Payment Gateway 230, the program continues to step 370. If at step 360 the payment processing was invalid, the program continues to step 380 where the program ends. At step 370, the program connects to the Order History Database Server 210 via the Network Router 250 and the Network 240 and stores the signature sample collected at step 310, the user unique identifier passed into the sign to buy function, the order unique identifier passed into the sign to buy function, and the transaction ID returned by the Payment Gateway 230. The program then continues to step 380 where it ends.

Several embodiments are specifically illustrated and/or described herein. However, it will be appreciated that modifications and variations are covered by the above teachings and within the scope of the appended claims without departing from the spirit and intended scope thereof.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A method for making a purchase order via sign to buy comprising the steps of:
(a) Clicking on a “Sign to Buy” button or similar button;
(b) Collecting a signature sample;
(c) Verifying biometric signature sample of Step (b);
(d) Getting user default credit card on file;
(e) Connecting to payment gateway to process the payment using the default credit card information of Step (d) and the amount of the order;
(f) Storing the signature sample of Step (b), order unique identifier, and transaction ID returned by payment gateway of Step (e).

2. The method of claim 1, wherein the signature sample is a signature generated by the movement of a finger, stylus, or computer mouse.
